(19) United States
(12) Patent Application Publication
(10) Pub. No.: US 2024/0210964 A1
(43) Pub. Date: Jun. 27, 2024

(54) AUTOMATIC ADJUSTMENT OF PARAMETER FOR MOTOR CONTROL

(71) Applicant: KABUSHIKI KAISHA YASKAWA DENKI, Kitakyushu-shi, Fukuoka (JP)

(72) Inventors: Tatsuya NAKAZAKI, Fukuoka (JP); Hirotaka MUTO, Fukuoka (JP); Masahiro KAWAZAWA, Fukuoka (JP)

(21) Appl. No.: 18/512,055

(22) Filed: Nov. 17, 2023

(30) Foreign Application Priority Data
Dec. 22, 2022 (JP) 2022-205681

(51) Int. Cl. G05D 3/20

(52) U.S. Cl. CPC G05D 3/20

(57) ABSTRACT

A motor control system includes circuitry configured to control a control object including a motor with a position detector, set a control parameter for controlling the control object, generate a control model representing a transfer function based on an operation command for generating the control model and an actual detection value detected by the position detector, and determine whether or not the control model is available for automatic adjustment of the control parameter. The circuitry is configured to adjust automatically the control parameter by a first automatic adjustment operation using the control model when it is determined that the control model is available for automatic adjustment, and to adjust automatically the control parameter by a second automatic adjustment operation without using the control model when it is determined that the control model is not available for automatic adjustment.

### CROSS-REFERENCE TO RELATED APPLICATIONS

This application is based upon and claims the benefit of priority from Japanese Patent Application No. 2022-205681, filed on Dec. 22, 2022, the entire contents of which are incorporated herein by reference.

### BACKGROUND

### Field

The present disclosure relates to a motor control system, and a method of automatically adjusting a control parameter.

### Description of the Related Art

Japanese Unexamined Patent Application Publication No. 2009-122779 discloses a control system including a servo system and a control support device. The servo system controls an electric motor for driving a load device. The control support device is connected to the servo system and automatically adjusts the value of an adjustment parameter which is set for controlling the electric motor to a predetermined target operation.

### SUMMARY

Disclosed herein is an example motor control system. The motor control may include circuitry configured to: control a control object including a motor with a position detector; set a control parameter for controlling the control object; generate a control model representing a transfer function based on an operation command for generating the control model and an actual detection value detected by the position detector; and determine whether or not the control model is available for automatic adjustment of the control parameter. Additionally, the circuitry may be configured to: adjust automatically the control parameter by a first automatic adjustment operation using the control model when it is determined that the control model is available for automatic adjustment; and adjust automatically the control parameter by a second automatic adjustment operation without using the control model when it is determined that the control model is not available for automatic adjustment.

Also disclosed herein is a method of automatically adjusting a control parameter. The method may include: setting a control parameter for controlling a control object including a motor with a position detector; generating a control model representing a transfer function based on an operation command for generating the control model and an actual detection value detected by the position detector; and determining whether or not the control model is available for automatic adjustment of the control parameter. In setting the control parameter, when it is determined that the control model is available for automatic adjustment, the control parameter is automatically adjusted by a first automatic adjustment operation using the control model.

### BRIEF DESCRIPTION OF THE DRAWINGS

FIG. 1 is a schematic diagram of an example motor control system.

FIG. 2 is a schematic diagram illustrating an example control executed by a controller.

FIG. 3A is a graph for explaining an example of automatic adjustment.

FIG. 3B and FIG. 3C are diagrams of an example control model or transfer function.

FIG. 4 is a schematic diagram of an example hardware configuration of a motor control system.

FIG. 5 is a flowchart illustrating an example of an automatic adjustment method.

FIG. 6 is a flowchart illustrating an example of a first automatic adjustment method.

FIG. 7A is a flowchart illustrating an example method of estimating a control parameter.

FIG. 7B illustrates an example of a stable region and an unstable region of a control system.

FIG. 8 is a graph illustrating an example of adjusting a control parameter.

### DETAILED DESCRIPTION

Hereinafter, with reference to the drawings, the same elements or similar elements having the same function are denoted by the same reference numerals, and redundant description will be omitted.

### Motor Control System

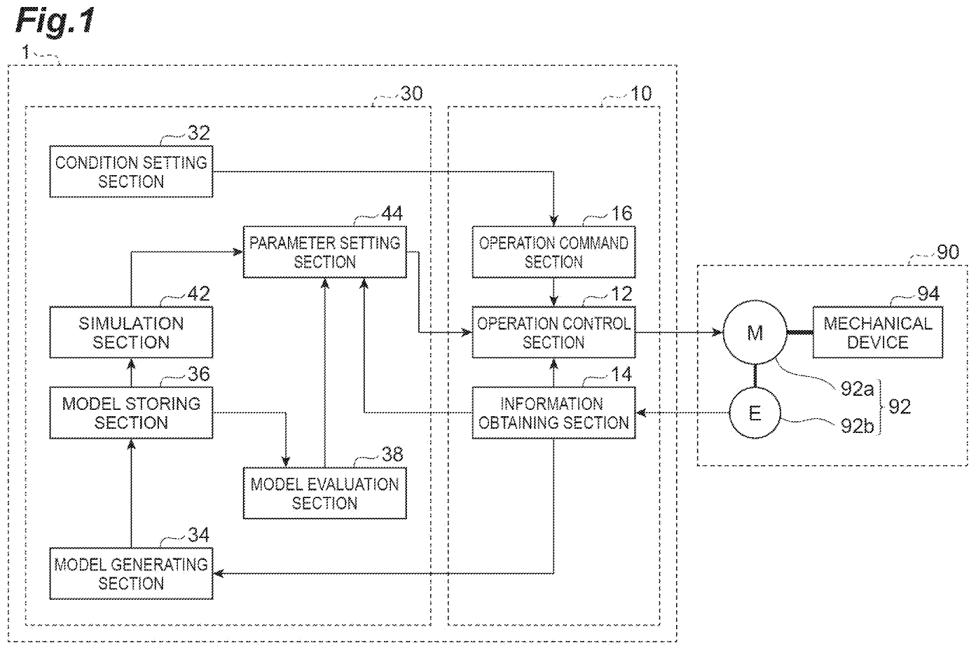

The motor control system 1 illustrated in FIG. 1 is a system that is configured to adjust automatically a control parameter for controlling a control object 90. The motor control system 1 is configured to control the control object 90 according to the adjusted the control parameter. The automatic adjustment of the control parameter means that the system (device) autonomously determines the value of the control parameter after the start of the adjustment. The control object 90 includes a motor 92 and a mechanical device 94 coupled to the motor 92. The motor 92 is, for example, a servo motor, a rotary motor, a linear motor, or other type of motor capable of operating the mechanical device 94.

The motor 92 includes a motor body 92a and a position detector 92b. The motor body 92a generates a driving force for moving at least a part of the mechanical device 94 in accordance with power (e.g., current) supplied from the motor control system 1. The position detector 92b obtains detection information indicating the position of the motor 92. The position detector 92b may obtain speed information indicating the speed (rotational speed) of the motor 92 as the detection information indicating the position of the motor 92. The position of the motor 92 can be calculated by integrating the speed of the motor 92 indicated by the speed information.

A motor control system 1 includes a controller 10 and a setting device 30. The controller 10 and the setting device 30 may be connected to communicate with each other when automatic adjustment of a control parameter is performed. The control parameter is used when the controller 10 controls the control object 90. After the automatic adjustment of the control parameter, the controller 10 may control the control object 90 (motor 92) in accordance with the control parameter without using the setting device 30.

The automatic adjustment of the control parameter may be performed when the apparatus which is the control object 90 is operated for the first time or every time the apparatus which is the control object 90 is maintained. In the present disclosure, a phase of performing automatic adjustment of the control parameter is referred to as an “adjustment phase”, and a phase of performing control of the control object 90 is referred to as an “operation phase”. The operation phase is performed after automatic adjustment is implemented in the adjustment phase. Hereinafter, each of the controller 10 and the setting device 30 will be described.

### Controller

The controller 10 is a computer device that controls the control object 90. The controller 10 controls the control object 90 (motor 92) so that the position of the motor 92 follows a target position. The controller 10 may also be referred to as a servo amplifier. The controller 10 includes a functional configuration (hereinafter referred to as “functional module”). For example, the controller 10 includes an operation control section 12, an information obtaining section 14, and an operation command section 16 as functional modules. The processes executed by these functional modules correspond to processes executed by the controller 10.

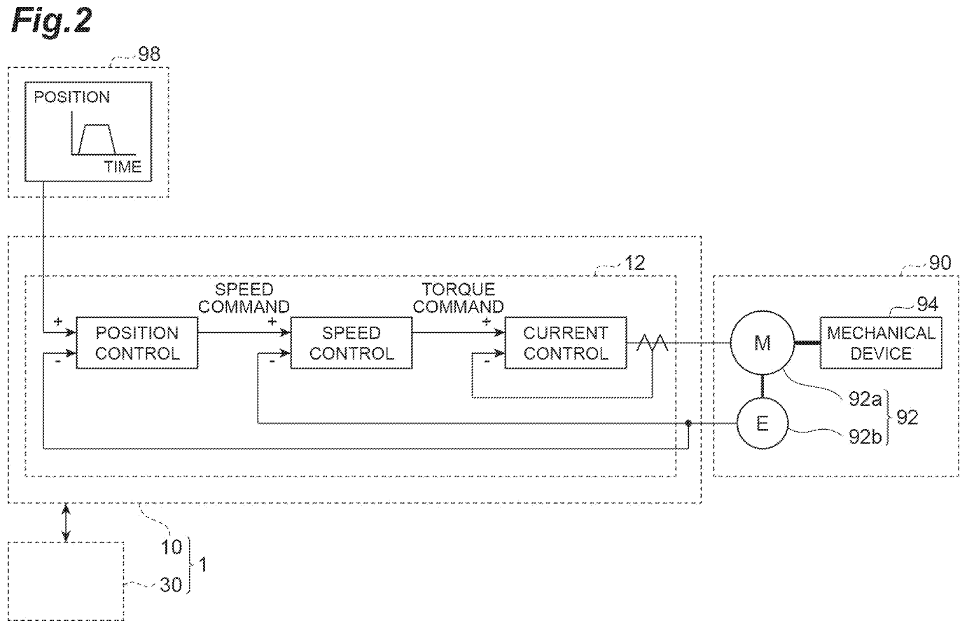

The operation control section 12 is a functional module to control the control object 90 including the motor 92 with the position detector 92b. The operation control section 12 may control the control object 90 based on the detection information obtained from the position detector 92b for the position of the motor 92 to follow the target position. When controlling the control object 90, the operation control section 12 may adjust the current value supplied to the motor 92 based on the detection information from the position detector 92b so that the position of the motor 92 approaches the target position. FIG. 2 schematically illustrates a content of control executed by the operation control section 12.

The operation control section 12 may constitute at least a speed control system. A control by the operation control section 12 may include a speed control system. For example, the operation control section 12 may control a speed of the control object 90 based, at least in part, on a speed proportional gain. The operation control section 12 may execute the control of the control object 90 so as to reduce a deviation between the speed obtained from the position detector 92b and the command value of the speed based on the target position. An example content of the control executed by the operation control section 12 in the operation phase will be described. When the operation control section 12 constitutes a position and speed control system, for example, a position command representing the target position is input to the operation control section 12 from a host controller 98. In addition, detection information from the position detector 92b is input to the operation control section 12. As shown in FIG. 2, the operation control section 12 executes position control, speed control and current control.

In the position control, the operation control section 12 calculates a position deviation between a target position indicated by the position command and a detection position obtained from the detection information by the position detector 92b. In the position control, the operation control section 12 generates a speed command based on the position deviation and a position proportional gain so as to reduce the position deviation. In the speed control, the operation control section 12 calculates a speed deviation between a command value indicated by the speed command and a speed detection value obtained from the detection information by the position detector 92b. In the speed control, the operation control section 12 generates a torque command based on the speed deviation and a speed proportional gain so as to reduce the speed deviation.

In the current control, the operation control section 12 calculates a current value according to a torque command and generates a current having the calculated value. The operation control section 12 supplies the current according to the torque command to the motor 92. As the above controls are continued, the control object 90 is controlled so that the position of the motor 92 follows the target position.

Returning to FIG. 1, the information obtaining section 14 is a functional module that obtains the detection information from the position detector 92b. The information obtaining section 14 may obtain speed information (speed feedback) indicating the speed of the motor 92 from the position detector 92b as the detection information. The operation command section 16 is a functional module that inputs various operation commands for automatically adjusting the control parameter to the operation control section 12 in the adjustment phase. The operation command section 16 may input to the operation control section 12 a torque command as the operation command for adjustment.

### Setting Device

The setting device 30 is a computer device that executes a process for automatically adjusting at least a part of the control parameter in the operation control section 12. The control parameter to be adjusted in the automatic adjustment may include the speed proportional gain in the speed control. The setting device 30 may be an engineering tool that can be operated by a user such as a worker. The setting device 30 may have an input and output device for transfer some information between the setting device and the user. For example, the setting device 30 is connected to the controller 10 so as to communicate with the controller 10 in an adjustment phase for performing automatic adjustment.

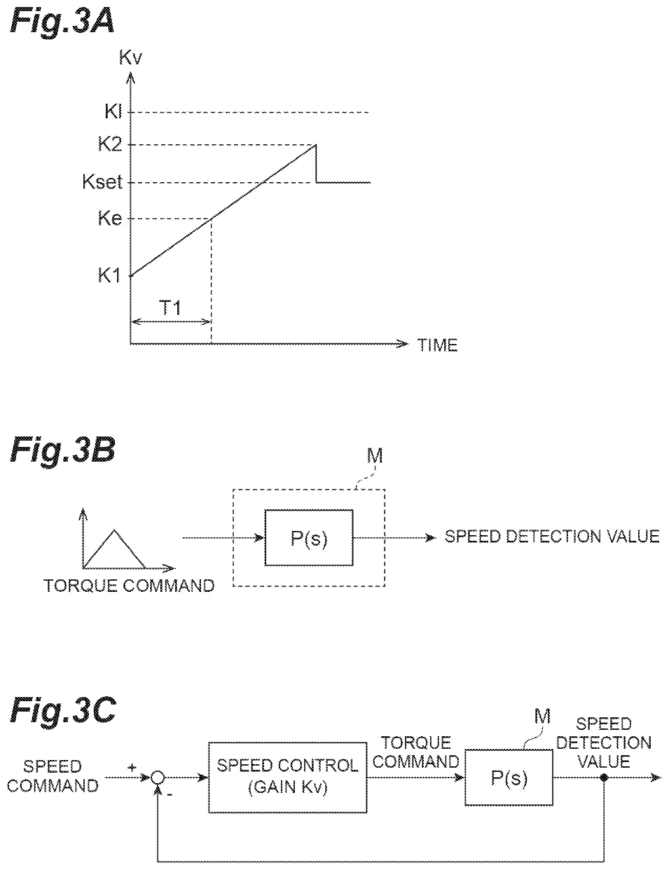

Here, in order to facilitate understanding of automatic adjustment in the present disclosure, an example automatic adjustment of the speed proportional gain (hereinafter referred to as “gain Kv”) is described below with reference to FIG. 3A. The gain Kv is one of the control parameters. From the viewpoint of control responsiveness, the value of the gain Kv is preferably large. However, if the gain Kv is set to a value that is too large, oscillation occurs in the control system. In other words, the control system becomes unstable. Therefore, in the automatic adjustment of the gain Kv, the gain Kv is adjusted (or set) to a value as large as possible within a range in which oscillation does not occur in the control system.

In the automatic adjustment of the gain Kv, an operation command for adjustment is input to the operation control section 12. The operation command for adjustment is, for example, a command for the position of the motor 92 (or mechanical device 94) to reciprocate. The operation control section 12 supplies a current to the motor 92 in accordance with the operation command for adjustment to operate the motor 92. The operation control section 12 gradually increases the value of the gain Kv from a certain initial value while operating the motor 92 in accordance with the operation command for adjustment. The setting device 30 obtains the detection information from the position detector 92b during the period in which the control by the operation control section 12 continues. When the gain Kv is gradually increased, the control system having closed-loop goes from a stable state to a state in which vibration occurs. When the level of the vibration is further increased by increasing the gain Kv after the vibration occurs, the control system having closed-loop becomes an oscillating state (or unstable state).

The setting device 30 identifies the value of the gain Kv at which the vibration in the control system having closed-loop is detected from the detection information obtained by the position detector 92b. Then, the setting device 30 sets the gain Kv at a value by considering the safety factor with respect to the value of the gain Kv at which the vibration is detected. In FIG. 3A, an initial value when the gain Kv is gradually increased is indicated by “K1”, a value when vibration is detected is indicated by “K2”, and a value set (or automatically adjusted) as a value of the gain Kv is indicated by “Kset”. When a predetermined condition is satisfied, the setting device 30 performs automatic adjustment of the gain Kv with using a calculation in a simulation.

Referring back to FIG. 1, for example, the setting device 30 includes, as functional modules, a condition setting section 32, a model generating section 34, a model storing section 36, a model evaluation section 38, a simulation section 42, and a parameter setting section 44. The processes executed by these functional modules correspond to the processes executed by the setting device 30.

The condition setting section 32 is a functional module that outputs various instructions for performing automatic adjustment to the controller 10. The condition setting section 32, for example, sets the controller 10 to the automatic adjustment operation mode based on a user input. Further, the condition setting section 32 sets a condition for an operation command to be used for automatic adjustment based on a user input, and then outputs the operation command to the operation command section 16 of the controller 10. In the controller 10 set to the automatic adjustment operation mode, the operation control section 12 operates the motor 92 based on the operation command from the operation command section 16, and the information obtaining section 14 obtains the detection information from the position detector 92b and outputs the detection information to the setting device 30.

The model generating section 34 is a functional module that generates a control model representing a transfer function based on an operation command for generating the control model and detection information from the position detector 92b. The control model is a model in which the content of controlling the control object 90 is expressed by a formula using a transfer function. The transfer function (or the control model) is generated, for example, as shown in FIG. 3B, so as to output a predicted value of a detection result of the position detector 92b in accordance with an input of a torque command representing a time change of a command value of torque. Hereinafter, the control model generated by the model generating section 34 will be referred to as “control model M”.

In FIG. 3B, “P(s)” represents a transfer function in the control model M. Note that the transfer function in the control model M may be a transfer function of a discrete system obtained by being converted into the z domain. In the present disclosure, a predicted value of the detection result of the position detector 92b in the control model M is referred to as a “predicted detection value of the position detector 92b”, and detection information actually obtained from the position detector 92b is referred to as an “actual detection value of the position detector 92b”.

When the control model M is generated, the operation command section 16 inputs an operation command for generating the control model to the operation control section 12 based on an instruction from the condition setting section 32. The operation command for generating the control model is, for example, a torque command for model generation. The operation command for generating the control model may be a torque command constituted by sine waves of a plurality of frequencies. The model generating section 34 obtains the actual detection value of the position detector 92b from the information obtaining section 14 when the operation control section 12 operates the motor 92 based on the operation command for generating the control model. The model generating section 34 may generate the control model M based on the actual detection value of the position detector 92b when the motor 92 is operated in accordance with the operation command for generating the control model by one of various known techniques.

The model storing section 36 is a functional module that stores the control model M generated by the model generating section 34. Since the model generating section 34 generates the control model M, simulation using the control model M is available when automatic adjustment of the control parameter is performed. Although the time required for the automatic adjustment can be shortened by performing the automatic adjustment using the simulation with the control model M, the control model M may not be suitable for simulation depending on the characteristics of the mechanical device 94. Therefore, the motor control system 1 determines whether or not the control model M is available, and performs automatic adjustment of the control parameter.

The model evaluation section 38 determines whether or not the control model M is available for automatic adjustment of the control parameter. For example, the model evaluation section 38 determines that the control model M is not available for automatic adjustment when the error included in the output of the control model M is large, and determines that the control model M is available for automatic adjustment when the error included in the output of the control model M is small.

The model evaluation section 38 may determine whether or not the control model M is available for automatic adjustment of the control parameter based on a comparison between a predetermined threshold value and an output value of the control model M obtained when an operation command for evaluation is input to the control model M. The operation command for evaluation may be a torque command having sine wave of an unstable pole frequency, and the output value used for evaluation may be a position amplitude. When the control model M outputs a predicted detection value of the velocity (a predicted value of velocity feedback) by the position detector 92b, the time change of the predicted value of the position is calculated by integrating the predicted detection value of the velocity, and the position amplitude is obtained.

The unstable pole frequency is a frequency at which the real part of the pole of the transfer function in the control model M does not become negative. The poles of the transfer function in the control model M may be represented by complex numbers. When a torque command represented by a sine wave having an unstable pole frequency (a sine wave torque command having an unstable pole frequency) is input to the control model M, the output of the control model M includes vibrations and tends to become large. Even if a command of the unstable pole frequency which tends to increase the output value is input, when the position amplitude which is the output value is small, it can be considered that the error included in the output of the control model M is large. Therefore, in an example of a method for determining whether or not the control model M is available, the control model M is evaluated by focusing on the unstable pole frequency. It should be noted that comparing the output value of the control model M with a predetermined threshold value (for example, comparing the position amplitude with the predetermined threshold value) includes not only directly comparing the output value with the threshold value but also performing an evaluation substantially equal to the comparison between the output value and the threshold value.

The simulation section 42 estimates at least a part of the control parameter with using the control model M. For example, the simulation section 42 performs the estimation with using a closed-loop transfer function (hereinafter referred to as “transfer function for estimation”) including the speed control of the operation control section 12 and the control model M. In FIG. 3C, an example transfer function for estimation is illustrated. The output of the transfer function for estimation varies depending on the value of gain Kv. The simulation section 42 may estimate the gain Kv based on the transfer function for estimation. In one example, the simulation section 42 estimates the value of the gain Kv that corresponds to the oscillation limit (the boundary at which the control system transitions from the stable state to the unstable state) based on the transfer function for estimation.

The parameter setting section 44 is a functional module that sets the control parameter in the operation control section 12. The parameter setting section 44 automatically adjusts the control parameter and sets it in the operation control section 12 by performing either one of a first automatic adjustment method (first automatic adjustment operation) and a second automatic adjustment method (second automatic adjustment operation) based on the evaluation result by the model evaluation section 38. The first automatic adjustment method is an automatic adjustment method with using the control model M. The second automatic adjustment method is an automatic adjustment method without using the control model M. An example of automatic adjustment of the control parameter by the parameter setting section 44 will be described later.

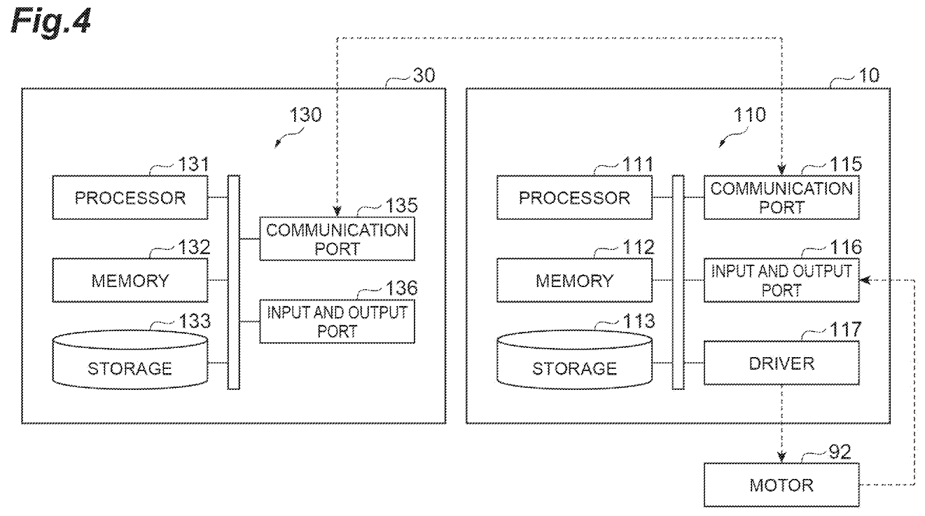

As shown in FIG. 4, the controller 10 includes circuitry 110. The circuitry 110 includes one or more processors 111, a memory 112, storage 113, a communication port 115, an input and output port 116, and a driver 117. The storage 113 is a non-volatile storage medium (e.g., flash memory) readable by a computer. The storage 113 stores a program for controlling the motor 92. The storage 113 also stores a program and data for automatic adjustment of the control parameter in cooperation with the setting device 30. The memory 112 temporarily stores a program loaded from the storage 113 and a calculation result by the processor 111.

The processor 111 forms the function modules of the controller 10 by executing the program in cooperation with the memory 112. The communication port 115 communicates with the setting device 30 or the like via a wireless, wire, or network line in response to a command from the processor 111. The input and output port 116 receive an electrical signal from the motor 92 and outputs an electrical signal to the motor 92 in response to a command from the processor 111. For example, the input and output port 116 communicates with the position detector 92b of the motor 92. The driver 117 outputs power (current) for driving to the motor 92 in response to a command from the processor 111.

The setting device 30 includes circuitry 130. The circuitry 130 includes one or more processors 131, memory 132, storage 133, communication port 135, and input and output port 136. The storage 133 is a non-volatile storage medium (e.g., flash memory) readable by a computer. The storage 133 stores a program (automatic adjustment program) and a data for performing automatic adjustment of the control parameter in cooperation with the controller 10. The memory 132 temporarily stores a program loaded from the storage 133 and a calculation result by the processor 131.

The processor 131 forms the function modules of the setting device 30 by executing the program in cooperation with the memory 132. In response to a command from the processor 131, the communication port 135 communicates with the controller 10 or the like via a wireless, wire, or network line. In response to a command from the processor 131, the input and output port 136 receive an electrical signal from an input and output device or the like provided in the setting device 30 and outputs an electrical signal to the input and output device or the like.

### Method of Automatically Adjusting Control Parameter

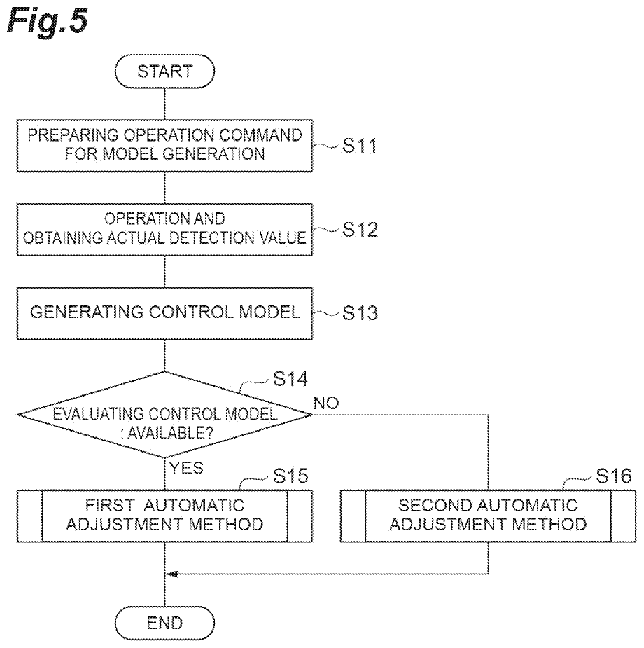

Next, with reference to FIGS. 5 to 8, a series of processes executed by the motor control system 1 in the adjustment phase will be described as an example method of automatically adjusting the control parameter. An example of automatic adjustment of the gain Kv (speed-proportional gain in the speed control system), which is one of the control parameters, will be described.

In this automatic adjustment method, at first the motor control system 1 executes operation S11 as shown in FIG. 5 in a state where the operation mode of the controller 10 is set to the automatic adjustment mode by the setting device 30. In operation S11, for example, the condition setting section 32 of the setting device 30 sets a condition of the operation command for generating the control model to be used for automatic adjustment based on a user input, and then outputs the operation command to the operation command section 16 of the controller 10. The operation command for generating the control model may be a torque command generated by combining a plurality of sine waves having different frequencies.

Next, the motor control system 1 executes operation S12. In operation S12, for example, the operation control section 12 supplies a current to the motor 92 of the control object 90 to operate the motor 92 in accordance with the operation command for model generation prepared in operation S11. Then, the model generating section 34 obtains an actual detection value (for example, an actual measurement value of the speed) of the position detector 92b when the motor 92 is operated according to the operation command for generating the control model.

Next, the motor control system 1 executes operation S13. In operation S13, for example, the model generating section 34 generates the control model M based on the actual detection value of the position detector 92b obtained in operation S12 by one of various known techniques. After the control model M is generated, the model storing section 36 stores the control model M.

Next, the motor control system 1 executes operation S14. In operation S14, for example, the model evaluation section 38 evaluates whether or not the control model M is suitable for simulation. The model evaluation section 38 may determine whether or not the control model M is available for automatic adjustment of the control parameter based on a comparison between a predetermined threshold value (predetermined value) and an output value of the control model M obtained when the operation command for evaluation is input to the control model M. In one example, the model evaluation section 38 determines that the control model M is available for automatic adjustment when the output value (e.g., position amplitude) of the control model M can be evaluated to be larger than the predetermined threshold value, the output value is obtained when the torque command having sine wave of the unstable pole frequency is input. The model evaluation section 38 determines that the control model M is not available for automatic adjustment when the output value (e.g., position amplitude) of the control model M can be evaluated to be smaller than the predetermined threshold value, the output value is obtained when the torque command having sine wave of the unstable pole frequency is input.

When it is determined in operation S14 that the control model M can be used for automatic adjustment, an operation executed by the motor control system 1 proceeds to operation S15. In operation S15, for example, the parameter setting section 44 executes automatic adjustment of the control parameter by the first automatic adjustment method with using the control model M. On the other hand, when it is determined in operation S14 that the control model M is cannot be used for automatic adjustment, an operation executed by the motor control system 1 proceeds to operation S16. In operation S16, for example, the parameter setting section 44 executes automatic adjustment of the control parameter by the second automatic adjustment method without using the control model M.

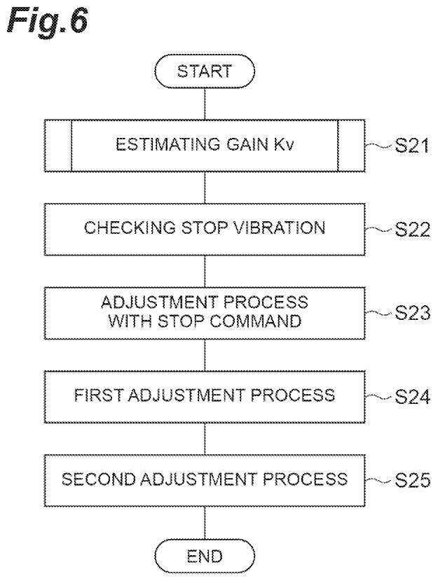

In one example, when it is determined that the control model M is available for automatic adjustment, the parameter setting section 44 automatically adjusts the gain Kv by the first automatic adjustment method and sets it in the operation control section 12. When it is determined that the control model M is not available for automatic adjustment, the parameter setting section 44 automatically adjusts the gain Kv by the second automatic adjustment method and sets it in the operation control section 12. FIG. 6 shows a series of operations in automatically adjusting the gain Kv by the first automatic adjustment method with using the control model M.

### First Automatic Adjustment Method

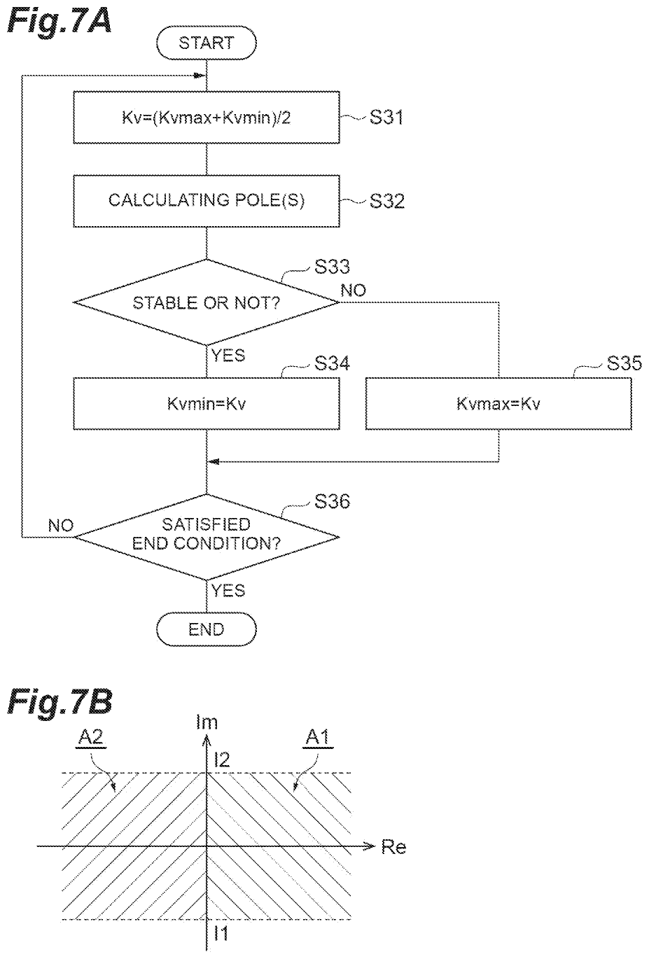

In the first automatic adjustment method (first automatic adjustment operation), at first the motor control system 1 executes operation S21. In operation S21, for example, the simulation section 42 estimates the value of the gain Kv corresponding to the boundary (or oscillation limit) between the unstable region and the stable region based on the transfer function for estimation in the control model M. In one example, the simulation section 42 derives poles (closed-loop poles) of the transfer function for the estimation for each value of gain Kv which is changed in accordance with the binary search. The simulation section 42 identifies the gain Kv having a pole which is on the boundary between the stable region and the unstable region based on the derived poles. The simulation section 42 sets the identified gain Kv as an estimated value. FIGS. 7A and 7B show an example of a method for estimating the gain Kv corresponding to the boundary by simulation using the control model M.

In the estimation of the gain Kv in operation S21, at first the setting device 30 executes operation S31. In operation S31, for example, the simulation section 42 calculates the center value between a current Kv max and a current Kv min, and sets the calculated value to the value of the current gain Kv. Kv max represents the upper limit of the range in which the gain Kv is varied when performing the estimation, and the initial value thereof is set in advance by the user, for example. The Kv min represents the lower limit of the range in which the gain Kv is varied when performing the estimation, and the initial value thereof is set in advance by the user, for example.

Next, the setting device 30 executes operations S32 and S33. In operation S32, for example, the simulation section 42 calculates one or more poles of the transfer function for estimation in which the gain Kv is set to the calculated value in operation S31. In operation S33, for example, the simulation section 42 determines whether or not the control system (the closed loop represented by the transfer function for estimation) in the case where the gain Kv is set to the calculated value in operation S31 is stable based on the one or more poles calculated in operation S32.

In FIG. 7B, a complex plane (s-plane) is illustrated, with the horizontal axis representing the real part and the vertical axis representing the imaginary part. Between the imaginary part −I1 and +I2, a region A1 having a real part larger than 0 can be defined as an unstable region, and a region A2 having a real part smaller than 0 can be defined as a stable region. The simulation section 42 may determine that the control system is unstable when a pole among the one or more poles calculated in operation S32 exists in the region A1 (unstable region). The simulation section 42 may determine that the control system is stable when none of the one or more poles calculated in operation S32 exists in the region A1 (unstable region).

When it is determined in operation S33 that the control system is stable, an operation executed by the setting device 30 proceeds to operation S34. In operation S34, for example, the simulation section 42 updates the Kv min representing the lower limit value to the current value of Kv. When it is determined in operation S33 that the control system is unstable, an operation executed by the setting device 30 proceeds to operation S35. In operation S35, for example, the simulation section 42 updates Kv max representing the upper limit value to the current value of Kv.

Next, the setting device 30 executes operation S36. In operation S36, for example, the simulation section 42 determines whether or not a predetermined end condition is satisfied. In one example, the simulation section 42 may determine that the end condition is satisfied when the difference between the current Kv max and the current Kv min is smaller than a predetermined value, and may determine that the end condition is not satisfied when the difference is equal to or greater than the predetermined value. The predetermined value used in operation S36 may be about several Hz (for example, 0.5 Hz to 3 Hz).

When it is determined in operation S36 that the end condition is not satisfied, an operation executed by the setting device 30 returns to operation S31. Then, the simulation section 42 again executes a series of operations S31 to S36 in a state where Kv max or Kv min is updated. On the other hand, when it is determined in operation S36 that the end condition is satisfied, the setting device 30 ends the series of operations. The simulation section 42 sets the value of the gain Kv at the time when the series of operations ends to an estimated value corresponding to the boundary between the stable region and the unstable region.

As described above, the estimated value of the gain Kv is calculated while changing (varying) the gain Kv in accordance with the binary search. Here, before operations after operation S22 are described, an outline of the first automatic adjustment method will be described. In the first automatic adjustment method, the parameter setting section 44 sets a value based on the estimated value of the gain Kv estimated in operation S21 to an initial value (first initial value) when performing automatic adjustment. For example, the parameter setting section 44 sets a value obtained by subtracting a predetermined number from the estimated value of the gain Kv obtained in operation S21 to an initial value for automatic adjustment.

In the first automatic adjustment method, the parameter setting section 44 may adjust the gain Kv and set it in the operation control section 12 based on the comparison between an amplitude threshold value and a vibration level included in the actual detection value of the position detector 92b, the actual detection value is obtained while the operation control section 12 to which a predetermined operation command has been input is controlling the control object 90 with increasing the gain Kv stepwise from the initial value based on the estimated value. The vibration level included in the actual detection value of the position detector 92b represents the magnitude of fluctuation when the actual detection value fluctuates around the target control amount (for example, the target position).

The vibration level included in the actual detection value of the position detector 92b may be measured from, for example, a torque command, a position detection value, a speed detection value, a position deviation, or a speed deviation. The amplitude threshold value is set, for example, to a value that may be evaluated when the vibration level is about to transition to the oscillation state. The amplitude threshold value may be set in advance by the user, or may be set based on the actual detection value when the control object 90 is controlled based on the operation command for setting before execution of operation S21.

After the execution of operation S21, the motor control system 1 executes operation S22 in a state where the gain Kv in the operation control section 12 is set to an initial value based on the estimated value calculated in operation S21. In operation S22, for example, the parameter setting section 44 checks whether or not a vibration (hereinafter referred to as “stop vibration”) is detected in the actual detection value of the position detector 92b while the operation control section 12 is operating the motor 92 in accordance with a stop command at a predetermined position in the control object 90. The stop command at a predetermined position in the control object 90 is a command set so that the motor 92 of the control object 90 stops at a certain position (rotational position).

In one example, the parameter setting section 44 checks whether or not the stop vibration is included in the actual detection value of the position detector 92b based on the comparison between a predetermined threshold value and a difference between the maximum value and the minimum value in torque command while the control is being performed in accordance with the stop command. When the stop command is input to the operation control section 12 and the stop vibration included in the actual detection value of the position detector 92b is confirmed, the parameter setting section 44 lowers the gain Kv from the initial value based on the estimated value obtained in operation S21 to a value at which the stop vibration is not confirmed. On the other hand, when the stop command is input to the operation control section 12 and no stop vibration is confirmed in the actual detection value of the position detector 92b, the operation control section 12 maintains the set value of the gain Kv at the initial value based on the estimated value obtained in operation S21, for example.

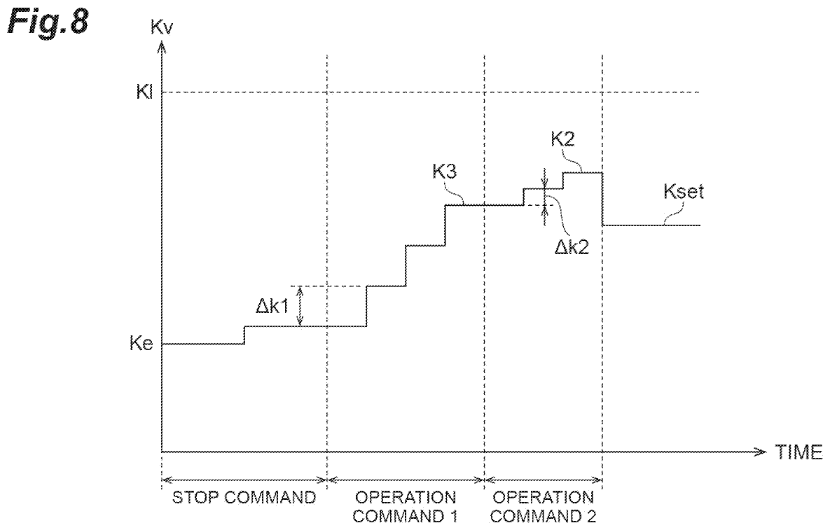

Next, the motor control system 1 executes operation S23. In operation S23, for example, a stop command at a predetermined position of the control object 90 is input to the operation control section 12, and the operation control section 12 controls the control object 90 in accordance with the stop command with increasing the gain Kv stepwise from the value set in operation S22 (the set value at which no stop vibration is confirmed). Then, while the control of the control object 90 by the operation control section 12 based on the stop command is being executed, the parameter setting section 44 adjusts the gain Kv in accordance with the vibration level obtained from the actual detection value of the position detector 92b. FIG. 8 shows an example adjustment of the gain Kv (an example time variation of the set value of the gain Kv) in a series of operations after operation S22.

In FIG. 8, the initial value based on the estimated value obtained in operation S21 is indicated by “Ke”. In the example shown in FIG. 8, the stop vibration is not confirmed in operation S22, and the gain Kv is set to the initial value Ke at the time of starting execution of operation S23. In one example, the parameter setting section 44 checks the presence or absence of the stop vibration every time the gain Kv is increased by a predetermined update amount. Then, the parameter setting section 44 increases the gain Kv until the stop vibration is confirmed, and sets the value at the time when the stop vibration is confirmed to the current gain Kv.

Next, the motor control system 1 executes operation S24. In operation S24, for example, an operation command for adjusting the gain is input to the operation control section 12, and the operation control section 12 controls the control object 90 in accordance with an operation command for adjusting the gain with increasing the gain Kv stepwise from the current value. For example, the operation control section 12 increases the gain Kv stepwise from the value adjusted in operation S23. While the operation control section 12 is controlling the control object 90 based on the operation command for adjusting the gain, the parameter setting section 44 adjusts the gain Kv based on a comparison between the amplitude threshold value and the vibration level obtained from the actual detection value of the position detector 92b. The operation command for adjusting the gain may be a command for reciprocating the movable portion of the control object 90 within a predetermined range.

In one example, in operation S24, the parameter setting section 44 detects the vibration level in the actual detection value of the position detector 92b while increasing the gain Kv stepwise by an update amount Δk1 (first update amount) as shown in FIG. 8. When the difference between the amplitude threshold value and the vibration level becomes smaller than a predetermined value before the vibration level reaches the amplitude threshold value, the parameter setting section 44 stops the gradual increase of the gain Kv by the update amount Δk1. Then, the parameter setting section 44 sets the value when the difference between the vibration level and the amplitude threshold value is smaller than the predetermined value to the current gain Kv. In FIG. 8, the value of the gain Kv when the difference between the vibration level and the amplitude threshold value is smaller than the predetermined value is indicated by “K3”.

In the adjustment using the operation command for adjusting the gain, the upper limit of the value of the gain Kv that is possible to be set (the upper limit of the range in which the gain Kv is changed) may be predetermined. In FIG. 8, the upper limit value of the gain Kv is indicated by “K1”. The upper limit value K1 is set so as to forcibly terminate the automatic adjustment regardless of the comparison between the vibration level and the amplitude threshold value, for example, in consideration of the safety of the apparatus. The parameter setting section 44 may stop the gradual increase of the gain Kv by the update amount Δk1 when the difference between the vibration level and the amplitude threshold value is smaller than a predetermined value or when the difference between the current gain Kv and the upper limit K1 is smaller than a predetermined value (for example, the update amount Δk1). The parameter setting section 44 may set the control parameter equal to or less than the upper limit value K1.

Next, the motor control system 1 executes operation S25. In operation S25, for example, an operation command for adjusting the gain is input to the operation control section 12, and the operation control section 12 controls the control object 90 in accordance with an operation command for adjusting the gain with increasing the gain Kv stepwise from the value adjusted in operation S24. The operation command for adjusting the gain used in operation S25 may be the same as or different from the operation command for adjusting the gain used in operation S24. While the operation control section 12 is controlling the control object 90 based on the operation command for adjusting the gain, the parameter setting section 44 adjusts the gain Kv based on the comparison between amplitude threshold value and the vibration level obtained from the actual detection value of the position detector 92b.

In one example, in operation S25, the parameter setting section 44 detects the vibration level in the actual detection value of the position detector 92b while increasing the gain Kv by the update amount Δk2 (second update amount) as shown in FIG. 8. The update amount Δk2 is set to a value smaller than the update amount Δk1. The update amount Δk2 may be about 1/2 to 1/10 times of the update amount Δk1. When the vibration level exceeds the amplitude threshold value, the parameter setting section 44 may stop the gradual increase of the gain Kv by the update amount Δk2. Then, the parameter setting section 44 sets the value when the vibration level exceeds the amplitude threshold value to the current gain Kv value.

In FIG. 8, the value of the gain Kv when the vibration level exceeds the amplitude threshold value is indicated by “K2”. The value K2 shown in FIG. 8 corresponds to “K2” shown in FIG. 3A. Even if the vibration level does not exceed the amplitude threshold value, the parameter setting section 44 may stop the gradual increase of the gain Kv by the update amount Δk2 when the value of the gain Kv reaches the upper limit value K1. When the value of the gain Kv reaches the upper limit value K1, the parameter setting section 44 sets the upper limit value K1 to the current gain value Kv.

After the adjustment of the gain Kv is performed in operation S25, as described with reference to FIG. 3A, the parameter setting section 44 may vary the value of the gain Kv to a value Kset in consideration of the safety factor with respect to the current value of the gain Kv at which the vibration is detected or has reached the upper limit. The parameter setting section 44 may set a value obtained by multiplying the value K2 or the upper limit value K1 by a value smaller than 1 (for example, 0.7 to 0.9) as the final adjustment value (value Kset) of the gain Kv.

In the series of operations in steps S22 to S25 described above, the parameter setting section 44 performs the following two processes when the stop vibration is not confirmed in the state where the gain Kv is set to the initial value Ke and the stop command at a predetermined position in the control object 90 is input to the operation control section 12. First, the parameter setting section 44 adjusts the gain Kv according to the vibration level detected while the operation control section 12 is controlling the control object 90 in accordance with the stop command at a predetermined position in the control object 90 with increasing the gain Kv stepwise from the initial value Ke. Thereafter, the parameter setting section 44 executes a first setting process. The first setting process includes adjusting and determining the gain Kv based on the comparison between the amplitude threshold value and the vibration level while the operation control section 12 is controlling the control object 90 with further increasing the gain Kv stepwise. When the gain Kv is set to the initial value Ke and the stop vibration is confirmed, the parameter setting section 44 lowers the gain Kv from the initial value Ke to a value at which the stop vibration is not confirmed, and then executes the above-mentioned two processes.

The parameter setting section 44 executes a first adjustment process and a second adjustment process in the setting process. The first adjustment process includes adjusting the gain Kv based on the vibration level with increasing the gain Kv stepwise by the update amount Δk1. The second adjustment process includes adjusting the gain Kv based on the vibration level with increasing the gain Kv stepwise by the update amount Δk2 which is smaller than the update amount Δk1. The first adjustment process is executed in operation S24, and the second adjustment process is executed in operation S25. When the difference between the vibration level and the amplitude threshold value becomes smaller than a predetermined value, an operation by the parameter setting section 44 shifts from the first adjustment process to the second adjustment process. Note that after execution of the first adjustment process (operation S24) and before execution of the second adjustment process (operation S25), another operation may be executed.

In the first automatic adjustment method with using the control model M, the initial value Ke of the gain Kv at the time of starting the automatic adjustment is determined based on the estimated value corresponding to the oscillation limit in the simulation, the estimated value is obtained with using the control model M. As a result, it is possible to perform automatic adjustment by increasing the gain Kv from a value close to the gain Kv which corresponds to oscillation limit in an actual apparatus (real machine). Therefore, the time required for automatic adjustment may be shortened. In FIG. 3A, a period which may be shortened by using the initial value Ke is indicated by “T1”.

Further, the update amount Δk1 of the gain Kv in operation S24 is larger than the update amount Δk2 of the gain Kv in operation S25. Therefore, the gain Kv may be finely adjusted in operation S25 after being easily and quickly adjusted to a value close to the oscillation limit in the actual machine in operation S24. As a result, the adjustment may be performed faster while maintaining the accuracy of the adjustment as compared with the case where the automatic adjustment is performed by increasing the gain Kv from the beginning to the end by the update amount Δk2.

### Second Automatic Adjustment Method

In the second automatic adjustment method (second automatic adjustment operation) that does not use the control model M, the motor control system 1 (setting device 30) sets the value of the gain Kv at the start of automatic adjustment to a predetermined initial value (second initial value) instead of executing operation S21. Hereinafter, in order to distinguish from the initial value Ke based on the estimated value in the first automatic adjustment method, the initial value of the gain Kv in the second automatic adjustment method is referred to as “initial value K1”. The initial value K1 may be set in advance by the user. After setting the gain Kv to the initial value K1, the motor control system 1 (setting device 30) may execute a series of operations similar to the operations S22 to S25 described above.

A series of operations corresponding to operations S22 to S25 in the second automatic adjustment method may be the same as operations S22 to S25 except that the initial value K1 is used instead of the initial value Ke. In the second automatic adjustment method, the parameter setting section 44 may adjust the gain Kv and set it in the operation control section 12 based on the comparison between an amplitude threshold value and a vibration level included in the actual detection value of the position detector 92b detected while the operation control section 12 is controlling the control object 90 in accordance with a predetermined operation command with increasing the amplitude Kv stepwise from the initial value K1.

In one example, the parameter setting section 44 performs the following two processes when the stop vibration is not confirmed in the state where the gain Kv is set to the initial value K1 and a stop command at a predetermined position in the control object 90 is input to the operation control section 12. First, the parameter setting section 44 adjusts the gain Kv according to the vibration level detected while the operation control section 12 is controlling the control object 90 in accordance with a stop command at a predetermined position in the control object 90 with increasing the gain Kv stepwise from the initial value K1. Thereafter, the parameter setting section 44 executes a second setting process. The second setting process includes adjusting and determining the gain Kv based on the comparison between the amplitude threshold value and the vibration level while the operation control section 12 is controlling the control object 90 with further increasing the gain Kv stepwise. When the gain Kv is set to the initial value K1 and the stop vibration is confirmed, the parameter setting section 44 lowers the gain Kv from the initial value K1 to a value at which the stop vibration is not confirmed, and then executes the above-mentioned two processes. The second setting process may include the first adjustment process and the second adjustment process as well as the first setting process in the first automatic adjustment method.

### Modification Example

The series of operations described in each of FIGS. 5, 6, 7A, and 7B is an illustrative example, and may be changed as appropriate. In any series of operations, the motor control system 1 may execute one step and the next step in parallel, or may execute each step in a different order from the example described above. The motor control system 1 may omit any step, or may execute a process different from the above-described example in any step. The motor control system 1 may additionally execute one or more operations different from the above-described example.

The speed control system constituted by the operation control section 12 may include a filter for suppressing vibration. The motor control system 1 (setting device 30) may set some control parameters related to the filter in addition to the gain Kv. The motor control system 1 may set some control parameters related to the filter after performing a series of operations S21 to S25. After the control parameters for the filter have been set, the motor control system 1 may also perform a series of operations S21 to S25. In the second operation S21, the motor control system 1 may estimate the gain Kv in consideration of the filter for which the parameter has been set.

After executing operation S24 (first adjustment process) and before proceeding to operation S25, the motor control system 1 may confirm whether or not stop vibration occurs at the gain Kv adjusted in operation S24. When the occurrence of the stop vibration is confirmed, the motor control system 1 may execute the similar operation to operation S23.

In some examples, the parameter setting section 44 terminates the first adjustment process when the difference between the vibration level and the amplitude threshold value becomes smaller than a predetermined value before the vibration level exceeds the amplitude threshold value. Alternatively, the parameter setting section 44 may terminate the first adjustment process when the vibration level exceeds the amplitude threshold value. Then, the parameter setting section 44 may set the current value of the gain Kv to a value obtained by subtracting the update amount Δk1 from the gain Kv when the vibration level exceeds the amplitude threshold value.

In some examples, in operation S21, the gain Kv is sequentially changed in accordance with the binary search to calculate an estimated value corresponding to oscillation limit. Alternatively, the simulation section 42 may gradually change the gain Kv from an initial lower limit value which is predetermined or an initial upper limit value which is predetermined to calculate an estimated value corresponding to oscillation limit.

The operation control section 12 may execute control in which feedforward control is combined with the above-described speed control system (speed feedback control). The motor control system 1 (setting device 30) may automatically adjust at least one of various control parameters other than the gain Kv in place of or in addition to the gain Kv.

Various functions of the controller 10 or various functions of the setting apparatus 30 are not limited to the above-mentioned examples. For example, the controller 10 may have at least part of the plurality of functional modules provided in the setting device 30 shown in FIG. 1, and the motor control system 1 may include the operation control section 12, the information obtaining section 14, the model generating section 34, the model evaluation section 38 and the parameter setting section 44.

Additionally, one or more features or operations described with respect to one example may be combined or rearranged in another example.

Example motor control systems may include the following configurations (1) to (12).

### Configuration (1)

A motor control system 1 may include an operation control section 12, a parameter setting section 44, a model generating section 34, a model evaluation section 38. The operation control section 12 is configured to control a control object 90 including a motor 92 with a position detector 92b. The parameter setting section 44 is configured to set a control parameter in the operation control section 12. The model generating section 34 is configured to generate a control model M representing a transfer function based on an operation command for generating the control model and an actual detection value detected by the position detector 92b. The model evaluation section 38 is configured to determine whether or not the control model M is available for automatic adjustment of the control parameter. When it is determined that the control model M is available for automatic adjustment, the parameter setting section 44 adjusts automatically the control parameter by a first automatic adjustment method with using the control model M. When it is determined that the control model M is not available for automatic adjustment, the parameter setting section 44 adjusts automatically the control parameter by a second automatic adjustment method without using the control model M.

It is conceivable to automatically adjust the value of a control parameter such as a speed proportional gain in a speed control system using the simulation result by a generated control model. For example, in a simulation, a varying range for adjusting a parameter with an actual machine may be calculated in advance. In this method, when an error included in the output of the generated control model is large, the varying range calculated in advance may not be an appropriate range, and an optimum value of the control parameter (for example, a gain value which is large and does not oscillate) may not be acquired. In this case, there is a possibility of causing instability of the control system in the actual machine, and further, there is a possibility of damaging the equipment included in the actual machine.

On the other hand, in the motor control system 1, it is determined whether or not the generated control model M is available, and automatic adjustment of the control parameter is performed by one of two automatic adjustment methods in which the use or non-use of the control model M is different. Therefore, when an error included in the output of the control model M is large, it is possible to avoid the automatic adjustment of the control parameter using the control model M. When the control model M is available, the control parameter may be set quickly by automatic adjustment using simulation. Therefore, the motor control system 1 is useful for both simplification and stabilization of the parameter adjustment operation.

### Configuration (2)

The motor control system 1 according to (1), wherein the model evaluation section 38 is configured to determine whether or not the control model M is available for automatic adjustment of the control parameter based on a comparison between a predetermined value and an output value of the control model M obtained when an operation command for evaluation is input to the control model M.

In this configuration, when the output value of the control model M is small, it is possible to be determined that the error included in the output of the model is large. Therefore, when the error of the estimation by the control model M is large, it is possible to avoid performing the automatic adjustment with using the simulation by the model.

### Configuration (3)

The motor control system 1 according to (2), wherein the operation command for evaluation is a torque command having sine wave of an unstable pole frequency; and the output value of the control model M is a position amplitude.

When a torque command having sine wave of an unstable pole frequency is input to the control model M, the position amplitude tends to be large. Even if the torque command having sine wave of an unstable pole is input to the control model M, when the position amplitude is small, it may be determined that the error is large in the output of the generated control model M. Therefore, in the above-described configuration, it is possible to determine whether or not the control model M is available by a simple command and the calculation load of the apparatus may be reduced.

### Configuration (4)

The motor control system 1 according to any one of (1) to (3), wherein the operation control section 12 is configured to form at least a speed control system, and the control parameter includes a gain Kv (speed proportional gain) in the speed control system.

When the error in the output of the control model M is large, if automatic adjustment is performed using the model, there is a possibility that a settling time in the speed control system is prolonged or an overshoot is increased. In the above-described configuration, when the error of the output of the control model M is large, it is possible to avoid automatically adjusting the speed proportional gain with using the control model M. Therefore, the adjustment operation of the speed-proportional gain may be stabilized.

### Configuration (5)

The motor control system 1 according to any one of (1) to (4) further includes a simulation section 42 configured to estimate at least a part of the control parameter with using the control model M. The parameter setting section 44, in the first automatic adjustment method, is configured to: calculate an initial value Ke (a first initial value) based on an value estimated with using the control model M; and adjust the control parameter based on a comparison between an amplitude threshold value and a vibration level included in the actual detection value detected by the position detector 92b while the operation control section 12 is controlling the control object 90 in accordance with a predetermined operation command with increasing the control parameter stepwise from the initial value Ke.

In this case, since the automatic adjustment is performed by increasing the control parameter from the initial value based on the estimated value obtained by using the control model M, the time required for the automatic adjustment may be shortened.

### Configuration (6)

The motor control system 1 according to any one of (1) to (4), wherein the parameter setting section 44, in the second automatic adjustment method, is configured to adjust the control parameter based on a comparison between an amplitude threshold value and a vibration level included in the actual detection value detected by the position detector 92b while the operation control section 12 is controlling the control object 90 in accordance with a predetermined operation command with increasing the control parameter stepwise from a predetermined initial value K1 (a second initial value).

In this case, since automatic adjustment is performed by increasing the control parameter from a predetermined initial value regardless of the output of the control model M, it is possible to stabilize the operation of adjusting the control parameter.

### Configuration (7)

The motor control system 1 according to (5), wherein the operation control section 12 is configured to form at least a speed control system, the control parameter includes a gain Kv in the speed control system, and the simulation section (42) is configured to derive poles in closed loop including the control model with changing the gain Kv in accordance with a binary search; identify the gain Kv having a pole which is on a boundary between a stable region and an unstable region based on calculated the poles; and set identified the gain Kv as the estimated value.

In this case, an initial value of a gain having a large value and not oscillating may be obtained by simulation, and by utilizing the initial value, a parameter can be quickly adjusted while maintaining a stable state of a control system in automatic adjustment using a real machine.

### Configuration (8)

The motor control system 1 according to (5) or (7), wherein the operation control section 12 is configured to form at least a speed control system, the control parameter includes a gain Kv in the speed control system, and a parameter setting section (44) is configured to sequentially execute a first process and a second process when no stop vibration included in the actual detection value is detected while the operation control section 12 is controlling the control object 90 in accordance with a stop command at a predetermined position in the control object 90; wherein the first process includes adjusting the gain Kv according to the vibration level detected while the operation control section 12 is controlling the control object 90 in accordance with a stop command at a predetermined position in the control object 90 with increasing the gain Kv stepwise from the initial value Ke, and wherein the second process includes a setting process to adjust and determine the gain Kv based on a comparison between the amplitude threshold value and the vibration level detected while the operation control section 12 is controlling the control object 90 in accordance with an operation command for adjusting a gain with further increasing the gain Kv stepwise.

In this case, the speed proportional gain may be set to an appropriate value for both the stop command and the operation command.

### Configuration (9)

The motor control system 1 according to (6), wherein the operation control section 12 is configured to form at least a speed control system, the control parameter includes the gain Kv in the speed control system, and the parameter setting section 44 is configured to sequentially execute a first process and a second process when no stop vibration included in the actual detection value is detected while the operation control section 12 is controlling the control object 90 in accordance with a stop command at a predetermined position in the control object 90; wherein the first process includes adjusting the gain Kv according to the vibration level detected while the operation control section 12 is controlling the control object 90 in accordance with a stop command at a predetermined position in the control object 90 with increasing the gain Kv stepwise from the initial value K1, and wherein the second process includes a setting process to adjust and determine the gain Kv based on a comparison between the amplitude threshold value and the vibration level detected while the operation control section 12 is controlling the control object 90 in accordance with an operation command for adjusting a gain with further increasing the gain Kv stepwise.

In this case, the speed proportional gain may be set to an appropriate value for both the stop command and the operation command.

### Configuration (10)

The motor control system 1 according to (8) or (9), wherein the parameter setting section 44 is configured to sequentially execute a first adjustment process and a second adjustment process in the setting process, wherein the first adjustment process includes adjusting the gain Kv based on the vibration level with increasing the gain Kv stepwise by a update amount Δk1 (a first update amount); and wherein the second adjustment process includes adjusting the gain Kv based on the vibration level with increasing the gain Kv stepwise by a update amount Δk2 (a second update amount) which is smaller than the update amount Δk1.

In this case, it is possible to reduce the number of updates of the gain Kv and the number of operations in the actual machine when performing the automatic adjustment with the actual machine, so that the time required for the automatic adjustment of the parameter may be shortened.

### Configuration (11)

A method of automatically adjusting a control parameter may include: setting a control parameter for controlling a control object 90 including a motor 92 with a position detector 92b; generating a control model M representing a transfer function based on an operation command for generating the control model M and an actual detection value detected by the position detector 92b; and determining whether or not the control model M is available for automatic adjustment of the control parameter; wherein in setting the control parameter: when it is determined that the control model M is available for automatic adjustment, the control parameter is automatically adjusted by a first automatic adjustment method with using the control model M; and when it is determined that the control model M is not available for automatic adjustment, the control parameter is automatically adjusted by a second automatic adjustment method without using the control model M.

This method is also useful for both simplification and stabilization of the parameter adjustment operation.

### Configuration (12)

A non-transitory memory device having instructions stored thereon that, in response to execution by a processing device, cause the processing device to perform operations according to (11).

Although certain procedures or operations are described herein as being performed sequentially or in a particular order, in some examples one or more of the operations may be performed in a different order, in parallel, simultaneously with each other, or in an overlapping manner. Additionally, in some examples, one or more of the operations may be optionally performed or, in some cases, omitted altogether.

We claim all modifications and variations coming within the spirit and scope of the subject matter claimed herein.

What is claimed is:

1. A motor control system comprising circuitry configured to:
control a control object including a motor with a position detector,
set a control parameter for controlling the control object;
generate a control model representing a transfer function based on an operation command for generating the control model and an actual detection value detected by the position detector,
determine whether or not the control model is available for automatic adjustment of the control parameter;
adjust automatically the control parameter by a first automatic adjustment operation using the control model when it is determined that the control model is available for automatic adjustment; and
adjust automatically the control parameter by a second automatic adjustment operation without using the control model when it is determined that the control model is not available for automatic adjustment.

2. The motor control system according to claim 1, wherein the circuitry is configured to determine whether or not the control model is available for automatic adjustment of the control parameter based on an output value of the control model obtained when an operation command for evaluation is input to the control model.

3. The motor control system according to claim 2, wherein the circuitry is configured to determine whether or not the control model is available for automatic adjustment of the control parameter based on a comparison between a predetermined value and the output value of the control model obtained when the operation command for evaluation is input to the control model.

4. The motor control system according to claim 2, wherein the operation command for evaluation is a torque command having sine wave of an unstable pole frequency, and
wherein the output value of the control model is a position amplitude.

5. The motor control system according to claim 1, wherein the control parameter includes a speed proportional gain, and
wherein the circuitry is configured to control a speed of the control object based, at least in part, on the speed proportional gain.

6. The motor control system according to claim 1, wherein the operation command for generating the control model is a torque command generated by combining a plurality of sine waves having different frequencies.

7. The motor control system according to claim 1, wherein the circuitry is further configured to estimate at least a part of the control parameter with using the control model, and
wherein in the first automatic adjustment operation the circuitry is configured to:
calculate a first initial value based on a value estimated with using the control model; and
adjust the control parameter based on a comparison between an amplitude threshold value and a vibration level included in the actual detection value detected by the position detector while the circuitry is controlling the control object in accordance with a predetermined operation command with increasing the control parameter stepwise from the first initial value.

8. The motor control system according to claim 7, wherein the circuitry is configured to set the control parameter equal to or less than an upper limit value.

9. The motor control system according to claim 7, wherein the circuitry is configured to calculate the first initial value by subtracting a predetermined number from the estimated value.

10. The motor control system according to claim 7, wherein the control parameter includes a speed proportional gain,
wherein the circuitry is configured to control a speed of the control object based, at least in part, on the speed proportional gain, and
wherein the circuitry is configured to:
calculate the speed proportional gain having a pole in closed loop including the control model, the pole being on a boundary between a stable region and an unstable region, and
set the calculated speed proportional gain as the estimated value.

11. The motor control system according to claim 7, wherein the control parameter includes a speed proportional gain,
wherein the circuitry is configured to control a speed of the control object based, at least in part, on the speed proportional gain, and
wherein the circuitry is configured to:
derive poles in closed loop including the control model with changing the speed proportional gain in accordance with a binary search;
identify the speed proportional gain having a pole which is on a boundary between a stable region and an unstable region based on derived the poles; and
set the identified speed proportional gain as the estimated value.

12. The motor control system according to claim 7, wherein the control parameter includes a speed proportional gain,
wherein the circuitry is configured to control a speed of the control object based, at least in part, on the speed proportional gain,
wherein the circuitry is configured to sequentially execute a first process and a second process when no stop vibration included in the actual detection value is detected while the circuitry is controlling the control object in accordance with a stop command at a predetermined position in the control object,
wherein the first process includes adjusting the speed proportional gain according to the vibration level detected while the circuitry is controlling the control object in accordance with a stop command at a predetermined position in the control object with increasing the speed proportional gain stepwise from the first initial value, and
wherein the second process includes a setting process to adjust and determine the speed proportional gain based on a comparison between the amplitude threshold value and the vibration level detected while the circuitry is controlling the control object in accordance with an operation command for adjusting a gain with further increasing the speed proportional gain stepwise.

13. The motor control system according to claim 12, wherein the circuitry is configured to sequentially execute a first adjustment process and a second adjustment process in the setting process,
wherein the first adjustment process includes adjusting the speed proportional gain based on the vibration level with increasing the speed proportional gain stepwise by a first update amount, and
wherein the second adjustment process includes adjusting the speed proportional gain based on the vibration level with increasing the speed proportional gain stepwise by a second update amount which is smaller than the first update amount.

14. The motor control system according to claim 1, wherein in the second automatic adjustment operation the circuitry is configured to adjust the control parameter based on a comparison between an amplitude threshold value and a vibration level included in the actual detection value detected by the position detector while the circuitry is controlling the control object in accordance with a predetermined operation command with increasing the control parameter stepwise from a predetermined second initial value.

15. The motor control system according to claim 14, wherein the circuitry is configured to set the control parameter equal to or less than an upper limit value.

16. The motor control system according to claim 14, wherein the control parameter includes a speed proportional gain,
wherein the circuitry is configured to control a speed of the control object based, at least in part, on the speed proportional gain,
wherein the circuitry is configured to sequentially execute a first process and a second process when no stop vibration included in the actual detection value is detected while the circuitry is controlling the control object in accordance with a stop command at a predetermined position in the control object,
wherein the first process includes adjusting the speed proportional gain according to the vibration level detected while the circuitry is controlling the control object in accordance with a stop command at a predetermined position in the control object with increasing the speed proportional gain stepwise from the second initial value, and
wherein the second process includes a setting process to adjust and determine the speed proportional gain based on a comparison between the amplitude threshold value and the vibration level detected while the circuitry is controlling the control object in accordance with an operation command for adjusting a gain with further increasing the speed proportional gain stepwise.

17. The motor control system according to claim 16, wherein the circuitry is configured to sequentially execute a first adjustment process and a second adjustment process in the setting process,
wherein the first adjustment process includes adjusting the speed proportional gain based on the vibration level with increasing the speed proportional gain stepwise by a first update amount, and
wherein the second adjustment process includes adjusting the speed proportional gain based on the vibration level with increasing the speed proportional gain stepwise by a second update amount which is smaller than the first update amount.

18. A method of automatically adjusting a control parameter comprising:
setting a control parameter for controlling a control object including a motor with a position detector;
generating a control model representing a transfer function based on an operation command for generating the control model and an actual detection value detected by the position detector; and
determining whether or not the control model is available for automatic adjustment of the control parameter,
wherein in setting the control parameter when it is determined that the control model is available for automatic adjustment, the control parameter is automatically adjusted by using the control model.

19. The method according to claim 18, wherein the control parameter includes a speed proportional gain, and
wherein controlling the control object includes controlling a speed of the control object based, at least in part, on the speed proportional gain.

20. A non-transitory memory device having instructions stored thereon that, in response to execution by a processing device, cause the processing device to perform operations comprising:
setting a control parameter for controlling a control object including a motor with a position detector;
generating a control model representing a transfer function based on an operation command for generating the control model and an actual detection value detected by the position detector, and
determining whether or not the control model is available for automatic adjustment of the control parameter,
wherein in setting the control parameter:
when it is determined that the control model is available for automatic adjustment, the control parameter is automatically adjusted by a first automatic adjustment operation using the control model; and
when it is determined that the control model is not available for automatic adjustment, the control parameter is automatically adjusted by a second automatic adjustment operation without using the control model.
